(19) United States
(12) Patent Application Publication
(10) Pub. No.: US 2009/0128469 A1
(43) Pub. Date: May 21, 2009

(54) Display Device and Electronic Device Provided with Same

(75) Inventor: Toshihiko Miyashita, Mie (JP)

Correspondence Address: HARNESS, DICKEY & PIERCE, P.L.C., P.O. BOX 8910, RESTON, VA, 20195, US

(73) Assignee: SHARP KABUSHIKI KAISHA, Osaka (JP)

(21) Appl. No.: 12/084,261

(22) PCT Filed: Jun. 6, 2006
(86) PCT No.: PCT/JP2006/311319

§ 371 Date: Apr. 29, 2008

(30) Foreign Application Priority Data
Nov. 10, 2005 (JP) 2005-325605

(51) Int. Cl. G09G 3/36

(52) U.S. Cl. 345/87

(57) ABSTRACT

The present invention relates to a display device and an electronic device provided with same.

An object of the present invention is to improve an electrostatic withstand voltage of the display device, thereby suppressing breakage of an electric circuit formed in a panel due to static electricity.

An intra-panel protective circuit (120) is provided between an input/output terminal (300) of a liquid crystal panel (10) and an intra-panel electric circuit (110), and, an intra-LSI protective circuit (220) is provided between the input/output terminal (300) of the liquid crystal panel (10) and a liquid crystal controller (210) in an LSI (200). A signal line connecting the input/output terminal (300) with the intra-panel electric circuit (110) and a signal line connecting the input/output terminal (300) with the liquid crystal controller (210) are connected with two diodes, respectively. On of the diodes is connected with signal lines (48, 28) to which a power supply voltage at a high potential is supplied, and the other one of the diodes is connected with signal lines (49, 29) to which a power supply voltage at a low potential is supplied.

### TECHNICAL FIELD

The present invention relates to a display device, more particularly, to a display device including a panel, which has an electric circuit formed therein, such as a CG silicon liquid crystal panel, and an electronic device provided with the display device.

### BACKGROUND ART

Recently, there has been developed a liquid crystal display device adopting a CG (Continuous Grain) silicon liquid crystal panel. The CG silicon liquid crystal panel denotes a liquid crystal panel that adopts, as a switching element, a TFT (Thin Film Transistor) formed of a CG silicon film. CG silicon has a structure in which grain boundaries are arranged regularly and have atomic-level continuity. Therefore, in the CG silicon, electrons can move at high speed and thus a driving integrated circuit can be mounted on a substrate of the liquid crystal panel. Thus, a reduction in cost and miniaturization of a device due to a reduction in the number of necessary components are advanced. Note that, in the following description, such a liquid crystal display device adopting the CG silicon liquid crystal panel is referred to as a “CG silicon liquid crystal display device”.

As a mounting method for the CG silicon liquid crystal display device, there have been known a COG (Chip On Glass) method in which an IC chip is mounted directly on a glass substrate of a liquid crystal panel, and a COF (Chip On Film) method in which an IC chip is mounted on an FPC (Flexible Printed Circuit). Examples of the CG silicon liquid crystal display device adopting the COG method include a display device in which a liquid crystal controller and a source driver (a video signal line drive circuit) are formed in an LSI mounted on a glass substrate and a gate driver (a scanning signal line drive circuit) is formed on a liquid crystal panel, and the like. Examples of the CG silicon liquid crystal display device adopting the COF method include a display device in which a liquid crystal controller is formed in an LSI mounted on an FPC and a gate driver and a source driver are formed on a liquid crystal panel.

FIG. 12 is an equivalent circuit diagram showing a partial configuration of a liquid crystal panel in a conventional CG silicon liquid crystal display device. As shown in FIG. 12, an electric circuit (hereinafter, referred to as an “intra-panel electric circuit”) 110 is formed on a liquid crystal panel 10. In addition, a plurality of input/output terminals 300 are provided on one end of the liquid crystal panel 10 to transmit the electric signals between the intra-panel electric circuit 110 and the outside of the liquid crystal panel 10. The plurality of input/output terminals 300 are connected with electronic elements such as TFTs 111 in the intra-panel electric circuit 110.

Herein, the input/output terminal 300 provided on the end of the liquid crystal panel 10 is subjected to no insulation treatment in order to establish an electrical connection with the outside of the liquid crystal panel 10. Therefore, as shown in FIG. 13, the input/output terminal 300 has a bared electrode. Consequently, the input/output terminal 300 receives external static electricity with ease, so that the intra-panel electric circuit 110 is broken by the static electricity in some cases. For example, when the input/output terminal 300 receives the static electricity, as shown in FIG. 12, the input/output terminal 300 rises in voltage, so that a gate terminal of the TFT 111 is broken. As a result, an electric current flows from the input/output terminal 300 into the gate terminal of the TFT 111. Herein, the breakage of the electric circuit due to the static electricity is called “electrostatic breakage”.

As shown in FIG. 14, typically, a protective circuit (hereinafter, referred to as an “intra-panel protective circuit”) 120 is provided between the input/output terminal 300 and the intra-panel electric circuit 110 in order to prevent the occurrence of the electrostatic breakage described above. In the example shown in FIG. 14, a DC/DC converter 40 which generates a power supply voltage used for driving the liquid crystal panel 10 is provided, and from the DC/DC converter 40 two types of power supply voltages are applied to the liquid crystal panel 10. The power supply voltage (hereinafter, referred to as a “high-potential side power supply voltage) VDD whose potential is the higher of the two power supply voltages is supplied from an input/output terminal 310 to a high-potential side power supply voltage line 38. On the other hand, the power supply voltage (hereinafter, referred to as a “low-potential side power supply voltage) VSS which has a lower potential is supplied from an input/output terminal 320 to a low-potential side power supply voltage line 39. In the intra-panel protective circuit 120, signal lines for connecting the input/output terminals 300 with the intra-panel electric circuit 110 are connected with two diodes 121 and 122, respectively. More specifically, the signal lines for connecting the input/output terminals 300 with the intra-panel electric circuit 110 are connected with an anode of the diode 121 and a cathode of the diode 122, respectively. Moreover, a cathode of the diode 121 is connected with the high-potential side power supply voltage line 38, and an anode of the diode 122 is connected with the low-potential side power supply voltage line 39.

In the configuration shown in FIG. 14, when the input/output terminal 300 receives positive static electricity, the input/output terminal 300 increases in potential. Thus, a forward voltage is applied to the diode 121, and positive electric charges resulting from the static electricity flow from the input/output terminal 300 into the high-potential side power supply voltage line 38. On the other hand, when the input/output terminal 300 receives negative static electricity, the input/output terminal 300 decreases in potential. Thus, a forward voltage is applied to the diode 122, and negative electric charges resulting from the static electricity flow from the input/output terminal 300 into the low-potential side power supply voltage line 39. As described above, the electric charges of the static electricity are discharged by the intra-panel protective circuit 120 so as to suppress occurrence of a malfunction to be caused due to electrostatic breakage of the intra-panel electric circuit 110.

Patent Document 1: Japanese Unexamined Patent Publication No. 9-080471

### DISCLOSURE OF THE INVENTION

### Problems to be Solved by the Invention

Depending on a use environment of the liquid crystal display device, however, the input/output terminal 300 of the liquid crystal panel 10 receives static electricity excessively in some cases. In an environment with less static electricity, such as a clean room, the electrostatic breakage can be prevented by the above-mentioned intra-panel protective circuit 120. In an environment with much static electricity, however, the occurrence of the electrostatic breakage can not be prevented only by provision of the intra-panel protective circuit 120.

Therefore, an object of the present invention is to improve an electrostatic withstand voltage of a display device, thereby suppressing breakage of an electric circuit formed in a panel due to static electricity.

### Means for Solving the Problems

A first aspect of the present invention is a display device including:

a display panel including a display unit for displaying an image, an electric circuit, and an input/output terminal for receiving a predetermined electric signal to be given to the electric circuit; and

an integrated circuit connected electrically with the display panel, wherein

the integrated circuit includes a first protective circuit for discharging electric charges of static electricity given to the input/output terminal.

According to a second aspect of the present invention, in the first aspect of the present invention, wherein

the electric circuit includes a drive circuit for displaying the image on the display unit, and

the integrated circuit controls operations of the drive circuit.

According to a third aspect of the present invention, in the first aspect of the present invention, wherein

the electric circuit includes a power supply circuit for activating a predetermined circuit in the display panel.

According to a fourth aspect of the present invention, in the first aspect of the present invention, wherein

the display panel includes a second protective circuit for discharging the electric charges of the static electricity given to the input/output terminal.

According to a fifth aspect of the present invention, in the fourth aspect of the present invention, wherein

the input/output terminal is connected with the first protective circuit and the second protective circuit.

According to a sixth aspect of the present invention, in the fourth aspect of the present invention, wherein

the first protective circuit is connected with the input/output terminal and the second protective circuit.

According to a seventh aspect of the present invention, in the first aspect of the present invention, wherein

the display panel includes a glass substrate, and

the integrated circuit is mounted on the glass substrate.

According to an eighth aspect of the present invention, in the first aspect of the present invention, the display device further including

a flexible printed circuit connected electrically with the display panel, wherein

the integrated circuit is mounted on the flexible printed circuit.

According to a ninth aspect of the present invention, in the second aspect of the present invention, wherein

the drive circuit is configured by a thin film transistor made of continuous grain silicon.

According to a tenth aspect of the present invention, in the second aspect of the present invention, wherein

the drive circuit is configured by a thin film transistor made of amorphous silicon.

According to an eleventh aspect of the present invention, in the second aspect of the present invention, wherein

the drive circuit is configured by a thin film transistor made of polysilicon.

A twelfth aspect of the present invention is an electronic device including

a display device having

a display panel including a display unit for displaying an image, an electric circuit, and an input/output terminal for receiving a predetermined electric signal to be given to the electric circuit, and

an integrated circuit connected electrically with the display panel, wherein

the integrated circuit includes a first protective circuit for discharging electric charges of static electricity given to the input/output terminal.

According to a thirteenth aspect of the present invention, in the twelfth aspect of the present invention, wherein

the electric circuit includes a drive circuit for displaying the image on the display unit, and

the integrated circuit controls operations of the drive circuit.

According to a fourteenth aspect of the present invention, in the twelfth aspect of the present invention, wherein

the electric circuit includes a power supply circuit for activating a predetermined circuit in the display panel.

According to a fifteenth aspect of the present invention, in the twelfth aspect of the present invention, wherein

the display panel includes a second protective circuit for discharging the electric charges of the static electricity given to the input/output terminal.

According to a sixteenth aspect of the present invention, in the fifteenth aspect of the present invention, wherein

the input/output terminal is connected with the first protective circuit and the second protective circuit.

According to a seventeenth aspect of the present invention, in the fifteenth aspect of the present invention, wherein

the first protective circuit is connected with the input/output terminal and the second protective circuit.

According to an eighteenth aspect of the present invention, in the twelfth aspect of the present invention, wherein

the display panel includes a glass substrate, and

the integrated circuit is mounted on the glass substrate.

According to a nineteenth aspect of the present invention, in the twelfth aspect of the present invention, the electronic device further including a flexible printed circuit connected electrically with the display panel, wherein

the integrated circuit is mounted on the flexible printed circuit.

According to a twentieth aspect of the present invention, in the thirteenth aspect of the present invention, wherein

the drive circuit is configured by a thin film transistor made of continuous grain silicon.

According to a twenty-first aspect of the present invention, in the thirteenth aspect of the present invention, wherein

the drive circuit is configured by a thin film transistor made of amorphous silicon.

According to a twenty-second aspect of the present invention, in the thirteenth aspect of the present invention, wherein

the drive circuit is configured by a thin film transistor made of polysilicon.

### EFFECTS OF THE INVENTION

According to the first aspect of the present invention, when the input/output terminal of the display panel receives static electricity, electric charges of the static electricity are discharged by the first protective circuit provided in the integrated circuit. Conventionally, electric charges of the static electricity have been discharged by a protective circuit provided in a display panel. Thus, a circuit configuration in a display panel can be simpler than those of conventional one and suppressing electrostatic breakage of an electric circuit in the display panel can be intended.

According to the second aspect of the present invention, when the input/output terminal of the display panel receives static electricity, suppressing electrostatic breakage of a drive circuit can be intended.

According to the third aspect of the present invention, when the input/output terminal of the display panel receives static electricity, suppressing electrostatic breakage of the power supply circuit can be intended.

According to the fourth aspect of the present invention, when the input/output terminal of the display panel receives static electricity, electric charges of the static electricity are discharged by the first protective circuit provided in the integrated circuit and the second protective circuit provided in the display panel. As described above, the electric discharge for preventing electrostatic breakage of the electric circuit in the display panel is performed not only by the protective circuit provided in the display panel and but also by the protective circuit provided in the integrated circuit. Therefore, if the input/output terminal of the display panel receives static electricity excessively, electric charges are divided, so that an electrostatic withstand voltage in the entire display device becomes high. Accordingly, the occurrence of a malfunction to be caused by electrostatic breakage of the electric circuit in the display panel can be suppressed.

According to the fifth aspect of the present invention, when the input/output terminal of the display panel receives static electricity, electric charges of the static electricity are distributed to the first protective circuit and the second protective circuit. Therefore, as in the case of the fourth aspect of the present invention, an electrostatic withstand voltage in the entire display device becomes high, and the occurrence of a malfunction to be caused by electrostatic breakage of the electric circuit in the display panel can be suppressed.

According to the sixth aspect of the present invention, when the input/output terminal of the display panel receives static electricity, electric charges of the static electricity discharged by the second protective circuit at first and, then, discharged by the first protective circuit. Therefore, as in the case of the fourth aspect of the present invention, an electrostatic withstand voltage in the entire display device becomes high, the occurrence of a malfunction to be caused by electrostatic breakage of the electric circuit in the display panel can be suppressed.

According to the seventh aspect of the present invention, in the display device adopting the COG method as a mounting method, the occurrence of a malfunction to be caused by electrostatic breakage of the electric circuit in the display panel can be suppressed.

According to the eighth aspect of the present invention, in the display device adopting the COF method as a mounting method, the occurrence of a malfunction to be caused by electrostatic breakage of the electric circuit in the display panel can be suppressed.

According to the ninth aspect of the present invention, in the display device in which the drive circuit is realized by a thin film transistor made of continuous grain silicon, the occurrence of a malfunction to be caused by electrostatic breakage of the electric circuit in the display panel can be suppressed. Moreover, electrons can move at high speed in the continuous grain silicon, so that reduction in cost and miniaturization of the display device due to a reduction in the number of necessary components can be realized.

According to the tenth aspect of the present invention, in the display device in which the drive circuit is realized by a thin film transistor made of amorphous silicon, the occurrence of a malfunction to be caused by electrostatic breakage of the electric circuit in the display panel can be suppressed.

According to the eleventh aspect of the present invention, in the display device in which the drive circuit is realized by a thin film transistor made of polysilicon, the occurrence of a malfunction to be caused by electrostatic breakage of the electric circuit in the display panel can be suppressed.

According to the twelfth aspect of the present invention, the electronic device, which can suppress the occurrence of a malfunction to be caused by electrostatic breakage of the electric circuit in the display panel, can be realized.

### BRIEF DESCRIPTION OF THE DRAWINGS

FIG. 1 is an equivalent circuit diagram showing detailed configurations of an intra-panel protective circuit, an intra-LSI protective circuit and a peripheral circuit thereof, in a first embodiment of the present invention.

FIG. 2 is a block diagram showing a general configuration of an analog full monolithic-type CG silicon liquid crystal display device according to the first embodiment.

FIG. 3 is a block diagram for describing an input/output terminal of a liquid crystal panel in a conventional CG silicon liquid crystal display device.

FIG. 4 is a block diagram showing a configuration according to a modification of the first embodiment.

FIG. 5 is a block diagram showing a general configuration of a monolithic-type CG silicon liquid crystal display device according to a second embodiment of the present invention.

FIG. 6 is a diagram for describing a connection between a liquid crystal panel and an LSI in the second embodiment.

FIG. 7 is a diagram for describing the connection between the liquid crystal panel and the LSI in the second embodiment.

FIG. 8 is an equivalent circuit diagram showing detailed configurations of an intra-panel protective circuit, an intra-LSI protective circuit and a peripheral circuit thereof, in the second embodiment.

FIG. 9 is an equivalent circuit diagram showing detailed configurations of an intra-LSI protective circuit and a peripheral circuit thereof, in a modification of the second embodiment.

FIG. 10A is a block diagram showing one configuration example of a liquid crystal display device adopting a COG method as a mounting method. FIG. 10B is a block diagram showing another configuration example of the liquid crystal display device adopting the COG method as a mounting method.

FIG. 11A is a block diagram showing one configuration example of a liquid crystal display device adopting a COG method or a COF method as a mounting method. FIG. 11B is a block diagram showing another configuration example of the liquid crystal display device adopting the COG method or the COF method as a mounting method.

FIG. 12 is an equivalent circuit diagram showing a partial configuration of a liquid crystal panel in a conventional CG silicon liquid crystal display device.

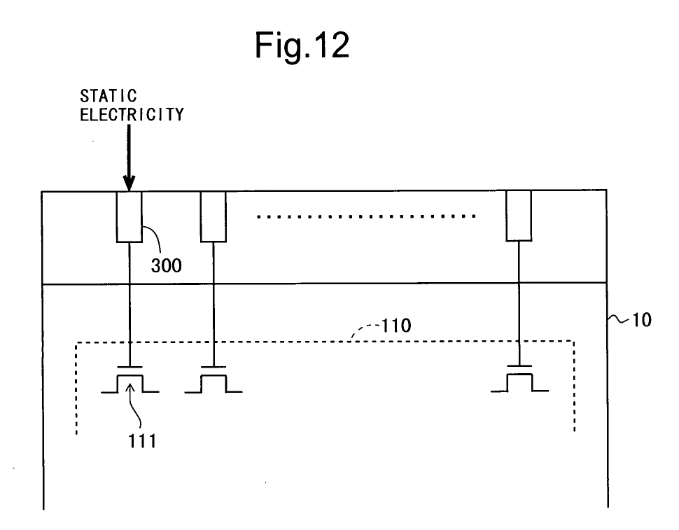

FIG. 13 is a diagram for describing an input/output terminal provided in the liquid crystal panel.

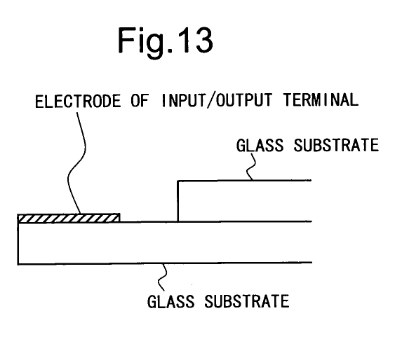

FIG. 14 is an equivalent circuit diagram showing a configuration of a protective circuit in the conventional CG silicon liquid crystal display device.

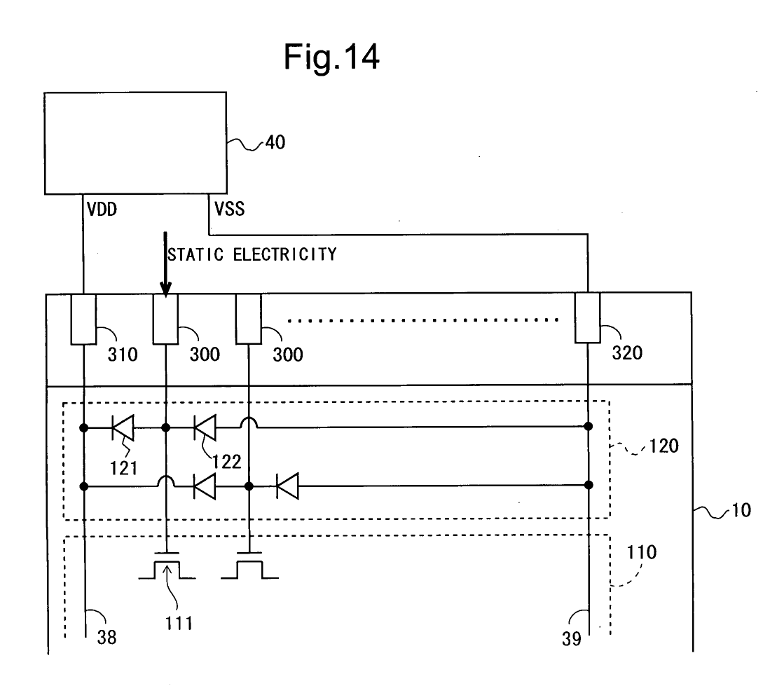

### DESCRIPTION OF THE SYMBOLS

10 . . . Liquid crystal panel
20 . . . FPC
30 . . . Terminal portion
40 . . . DC/DC converter
100 . . . Display unit
110 . . . Intra-panel electric circuit
120 . . . Intra-panel protective circuit
121, 122, 221, 222 . . . Diode
200 . . . LSI
210 . . . Liquid crystal controller
220 . . . Intra-LSI protective circuit
300 . . . Input/output terminal

### BEST MODE FOR CARRYING OUT THE INVENTION

With reference to the attached drawings, hereinafter, description will be given of preferred embodiments of the present invention.

### 1. First Embodiment

### 1.1 General Configuration of Liquid Crystal Display Device

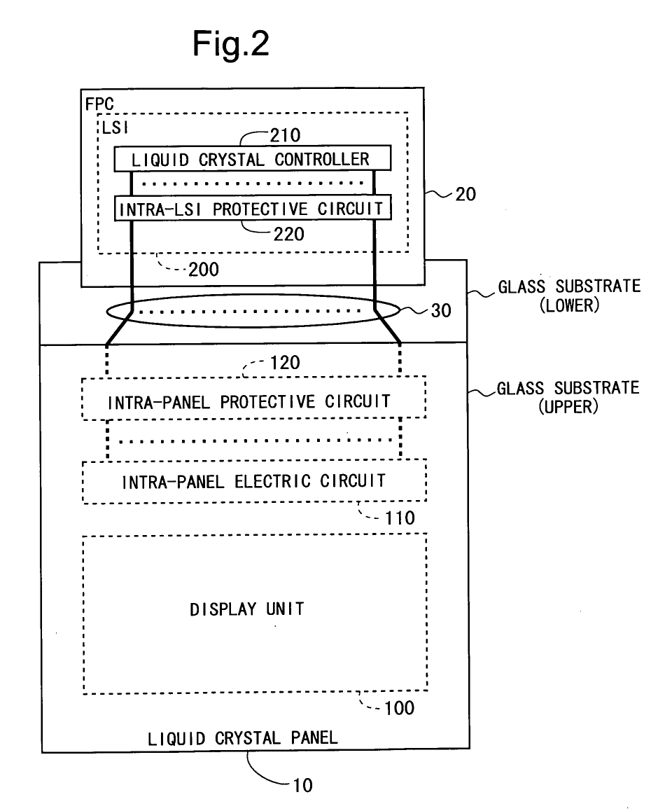

FIG. 2 is a block diagram showing a general configuration of an analog full monolithic-type CG silicon liquid crystal display device according to a first embodiment of the present invention. This liquid crystal display device includes a liquid crystal panel 10 serving as a display panel and an FPC 20, and adopts a COF method as a mounting method. The liquid crystal panel 10 is configured by two glass substrates which sandwich a liquid crystal layer, and has a display unit 100 which includes a gate bus line (a scanning signal line), a source bus line (a video signal line), a pixel electrode and the like, and displays an image, an intra-panel electric circuit 110 which includes a gate driver (a scanning signal line drive circuit) for driving the gate bus line and a source driver (a video signal line drive circuit) for driving the source bus line, and an intra-panel protective circuit 120 which serves as a second protective circuit for protecting the intra-panel electric circuit 110 from electrostatic breakage. On the FPC 20, an LSI 200 is mounted. The LSI 200 has a liquid crystal controller 210 for controlling operations of the gate driver and those of the source driver. The LSI 200 also has, as a first protective circuit, a circuit (hereinafter, referred to as an “intra-LSI protective circuit”) 220 for protecting the intra-panel electric circuit 110 from the electrostatic breakage, independently of the intra-panel protective circuit 120. Moreover, the liquid crystal panel 10 includes a terminal portion 30 consisting of a plurality of input/output terminals for connecting the intra-panel electric circuit 110 electrically with the LSI 200.

In FIG. 2, looking at the liquid crystal panel 10, the intra-panel protective circuit 120 is provided between the terminal unit 30 and the intra-panel electric circuit 110. On the other hand, looking at the FPC 20, the intra-LSI protective circuit 220 is provided between the terminal portion 30 of the liquid crystal panel 10 and the liquid crystal controller 210.

### 1.2 Configuration of Protective Circuit

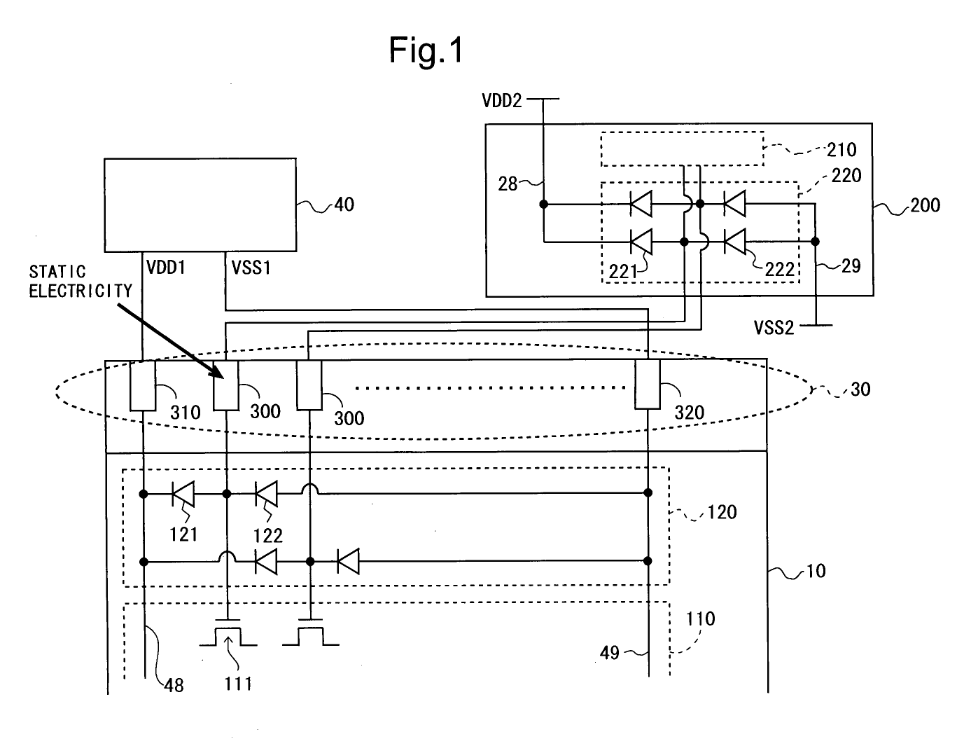

FIG. 1 is an equivalent circuit diagram showing detailed configurations of the intra-panel protective circuit 120, the intra-LSI protective circuit 220 and the peripheral circuit thereof. This liquid crystal display device includes a DC/DC converter 40 for generating two types of power supply voltages VDD1 and VSS1. The terminal portion 30 of the liquid crystal panel 10 includes the plurality of input/output terminals 300 for connecting the intra-panel electric circuit 110 electrically with the LSI 200, and the input/output terminals 310 and 320 for supplying the power supply voltages VDD1 and VSS1 generated by the DC/DC converter 40 to the liquid crystal panel 10. Note that, in the following description, the power supply voltage whose potential is the higher of the two power supply voltages is referred to as a “first high-potential side power supply voltage VDD1” and the power supply voltage which has a lower potential is referred to as a “first low-potential side power supply voltage VSS1”.

The liquid crystal panel 10 is also provided with a first high-potential side power supply voltage line 48 for supplying the first high-potential side power supply voltage VDD1 applied to the input/output terminal 310 to the electric circuit in the liquid crystal panel 10, and a first low-potential side power supply voltage line 49 for supplying the first low-potential side power supply voltage VSS1 applied to the input/output terminal 320 to the electric circuit in the liquid crystal panel 10.

In the intra-panel protective circuit 120, signal lines for connecting the input/output terminals 300 with the intra-panel electric circuit 110 are connected with two diodes 121 and 122, respectively. More specifically, the signal lines for connecting the input/output terminals 300 with the intra-panel electric circuit 110 are connected with an anode of the diode 121 and a cathode of the diode 122, respectively. Moreover, a cathode of the diode 121 is connected with the first high-potential side power supply voltage line 48, and an anode of the diode 122 is connected with the first low-potential side power supply voltage line 49.

As shown in FIG. 1, two types of power supply voltages VDD2 and VSS2 are applied to the LSI 200. Note that, in the following description, the power supply voltage whose potential is the higher of the two power supply voltages is referred to as a “second high-potential side power supply voltage VDD2”, and the power supply voltages which has a lower potential is referred to as a “second low-potential side power supply voltage VSS2”. The LSI 200 is provided with a second high-potential side power supply voltage line 28 for supplying the second high-potential side power supply voltage VDD2 to the electric circuit in the LSI 200, and a second low-potential side power supply voltage line 29 for supplying the second low-potential side power supply voltage VSS2 to the electric circuit in the LSI 200.

In the intra-LSI protective circuit 220, signal lines for connecting the input/output terminals 300 with the liquid crystal controller 210 are connected with two diodes 221 and 222, respectively. More specifically, the signal lines for connecting the input/output terminals 300 with the liquid crystal controller 210 are connected with an anode of the diode 221 and a cathode of the diode 222, respectively. Moreover, a cathode of the diode 221 is connected with the second high-potential side power supply voltage line 28, and an anode of the diode 222 is connected with the second low-potential side power supply voltage line 29.

### 1.3 Operations upon Reception of Static Electricity

With reference to FIG. 1, next, description will be made about operations when the input/output terminal 300 of the liquid crystal panel 10 receives static electricity, in the first embodiment.

When the input/output terminal 300 receives positive static electricity, the input/output terminal 300 increases in potential. Thus, when a forward voltage is applied to the diode 121, positive electric charges resulting from the static electricity flow partially from the input/output terminal 300 into the first high-potential side power supply voltage line 48. Moreover, when a forward voltage is applied to the diode 221, positive electric charges resulting from the static electricity flow partially from the input/output terminal 300 into the second high-potential side power supply voltage line 28.

When the input/output terminal 300 receives negative static electricity, the input/output terminal 300 decreases in potential. Thus, when a forward voltage is applied to the diode 122, negative electric charges resulting from the static electricity flow partially from the input/output terminal 300 into the first low-potential side power supply voltage line 49. Moreover, when a forward voltage is applied to the diode 222, negative electric charges resulting from the static electricity flow partially from the input/output terminal 300 into the second low-potential side power supply voltage line 29.

### 1.4 Effects

As described above, according to the present embodiment, when the input/output terminal 300 of the liquid crystal panel 10 receives static electricity, electric charges of the static electricity flow into the intra-panel protective circuit 120 provided in the liquid crystal panel 10 and the intra-LSI protective circuit 220 provided in the LSI 200 of the FPC 20. In a case where the input/output terminal 300 increases in potential, when a forward voltage is applied to the diode 121, positive electric charges flow into the first high-potential side power supply voltage line 48, and moreover, when a forward voltage is applied to the diode 221, positive electric charges flow into the second high-potential side power supply voltage line 28. On the other hand, in a case where the input/output terminal 300 decreases in potential, when a forward voltage is applied to the diode 122, negative electric charges flow into the first low-potential side power supply voltage line 49, and moreover, when a forward voltage is applied to the diode 222, negative electric charges flow into the second low-potential side power supply voltage line 29. Thus, the electric charges of the static electricity are discharged by the intra-panel protective circuit 120 and the intra-LSI protective circuit 220.

As described above, when the input/output terminal 300 of the liquid crystal panel 10 receives static electricity, electrical discharge for preventing electrostatic breakage of the intra-panel electric circuit 110 is performed not only by the intra-panel protective circuit 120 but also by the intra-LSI protective circuit 220. Therefore, even in a case where the input/output terminal 300 receives the static electricity excessively, electric charges of the static electricity are divided, so that an electrostatic withstand voltage in the entire display device becomes high. Accordingly, the occurrence of a malfunction to be caused due to electrostatic breakage of the intra-panel electric circuit 110 can be suppressed.

### 1.5 Modification

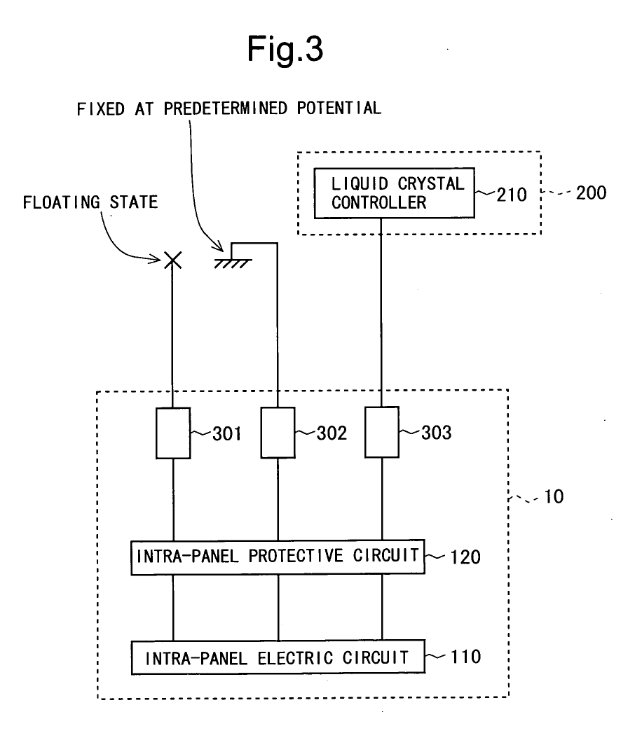

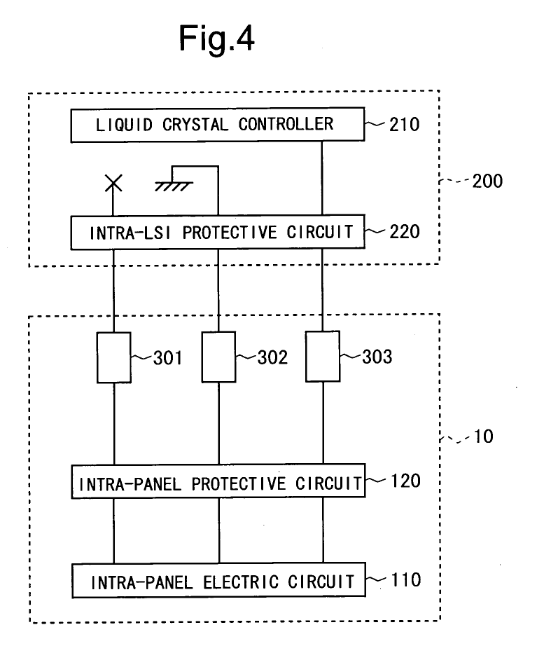

With reference to FIGS. 3 and 4, next, description will be given of a modification of the first embodiment. FIG. 3 is a block diagram for describing the input/output terminals provided in the liquid crystal panel 10 of the CG silicon liquid crystal display device. As shown in FIG. 3, conventionally, the input/output terminals of the liquid crystal panel 10 include an input/output terminal 303 for activating the display device with the use of a combination of the liquid crystal panel 10 with the LSI 200, and inspecting input/output terminals 301 and 302 for performing an inspection on the liquid crystal panel 10. Each of the inspecting input/output terminals 301 and 302 is not used for actually driving the display device and, therefore, is not connected with the LSI 200. Typically, each of the inspecting input/output terminals 301 and 302 is set at a floating state or is fixed at a predetermined potential such as a ground potential.

Herein, the inspecting input/output terminals 301 and 302 receive static electricity in some cases. Therefore, as shown in FIG. 4, it may be configured that the inspecting input/output terminals 301 and 302 are connected with the intra-LSI protective circuit 220. Thus, even when the inspecting input/output terminals 301 and 302 receive the static electricity, electrostatic breakage in the intra-panel electric circuit 110 can be suppressed effectively.

### 2. Second Embodiment

### 2.1 General Configuration of Liquid Crystal Display Device

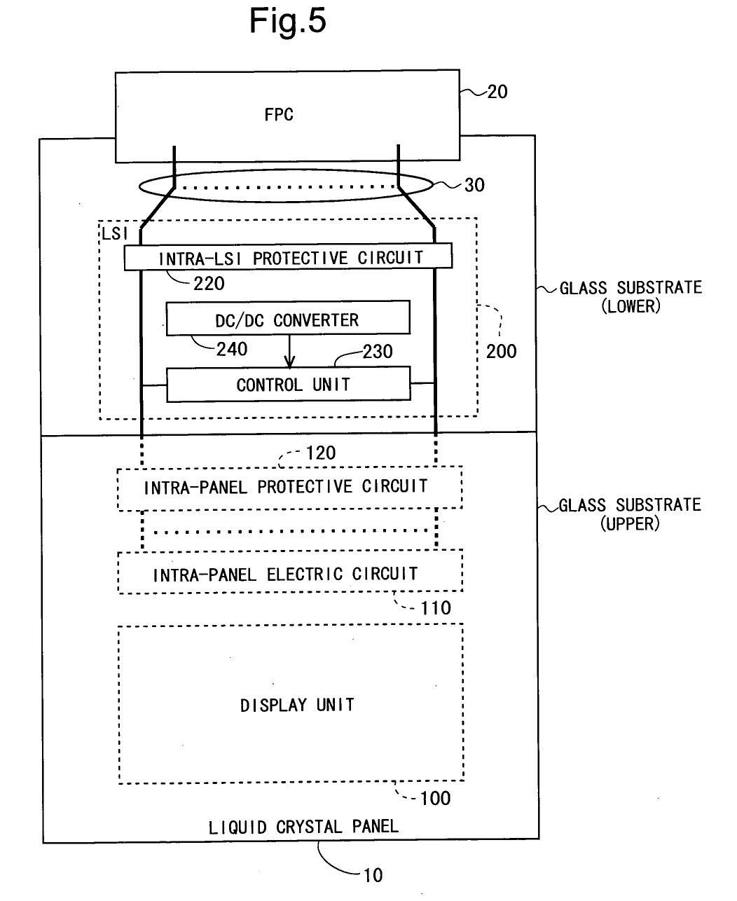

FIG. 5 is a block diagram showing a general configuration of a monolithic-type CG silicon liquid crystal display device according to a second embodiment of the present invention. This liquid crystal display device includes a liquid crystal panel 10 serving as a display panel and an FPC 20, and adopts a COG method as a mounting method. The liquid crystal panel 10 is configured by two glass substrates which sandwich a liquid crystal layer, and has a display unit 100 which includes a gate bus line, a source bus line, a pixel electrode and the like, and displays an image, an intra-panel electric circuit 110 which includes a gate driver for driving the gate bus line, and an intra-panel protective circuit 120 which serves as a second protective circuit for protecting the intra-panel electric circuit 110 from electrostatic breakage. Further, on the liquid crystal panel 10, an LSI 200 is mounted. The LSI 200 includes an intra-LSI protective circuit 220, which is for protecting the intra-panel electric circuit 110 from electrostatic breakage independently of the intra-panel protective circuit 12, a control unit 230, and a DC/DC converter 240. The intra-LSI protective circuit 220 protects. The control unit 230 includes a source driver for driving the source bus line, and a display control circuit for controlling operations of the source driver and operations of the gate driver in the intra-panel electric circuit 110. Moreover, the liquid crystal panel 10 includes a terminal portion 30 consisting of a plurality of input/output terminals for connecting the LSI 200 electrically with signal wires formed on the FPC 20. Note that, the same constituent elements as the first embodiment are denoted by the identical reference numerals. In the present embodiment, moreover, a line sequential driving method is adopted as a driving method.

As shown in FIG. 5, the input/output terminals in the terminal portion 30 are connected with the intra-LSI protective circuit 220. In addition, the intra-LSI protective circuit 220 is connected with the intra-panel protective circuit 120. Further, the intra-panel protective circuit 120 is connected with the intra-panel electric circuit 110.

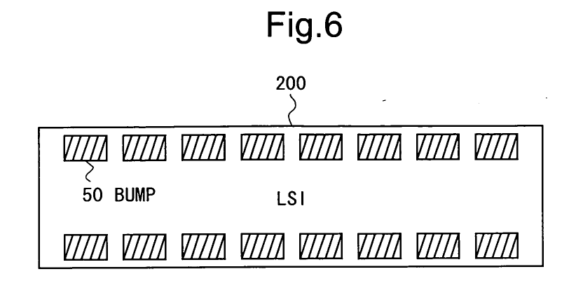

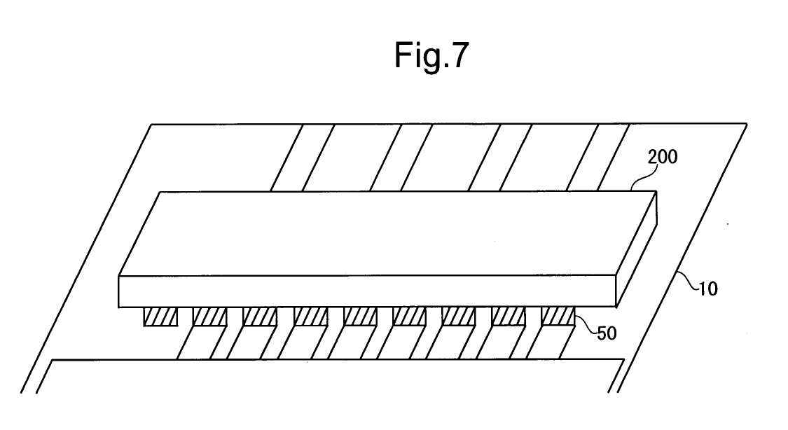

With reference to FIG. 6 and FIG. 7, herein, description will be given of a connection between the liquid panel 10 and the LSI 200 in the liquid crystal display device adopting the COG method as a mounting method. As shown in FIG. 6, the LSI 200 is provided with a plurality of bumps 50. Typically, the bump 50 is made of gold. An ACF (Anisotropic Conductive Film) is held between each bump 50 and each signal wire formed on the liquid crystal panel 10, and is applied heat and pressure. Thus, an electrode on the liquid crystal panel 10 is connected electrically with an electrode on the LSI 200. Hence, as shown in FIG. 7, the electric circuit formed on the liquid crystal panel 10 is connected electrically with the LSI 200.

### 2.2 Configuration of Protective Circuit

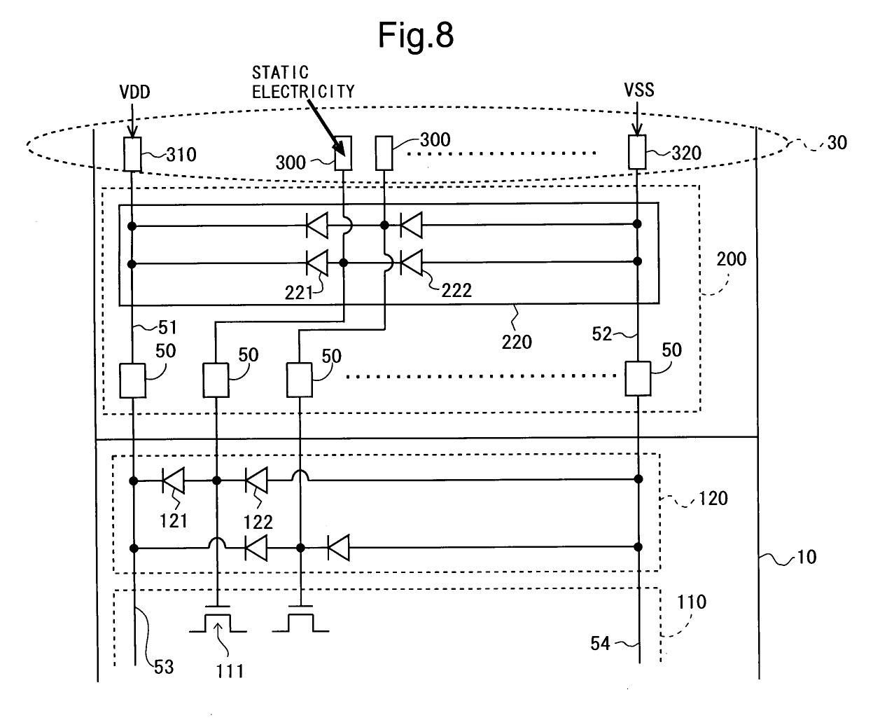

FIG. 8 is an equivalent circuit diagram showing detailed configurations of the intra-panel protective circuit 120, the intra-LSI protective circuit 220 and the peripheral circuit thereof. Two types of power supply voltages VDD and VSS are applied to the liquid crystal panel 10 of the liquid crystal display device. Note that, in the following description, the power supply voltage whose potential is the higher of the two power supply voltages is referred to as a “high-potential side power supply voltage VDD” and the power supply voltage which has a lower potential is referred to as a “low-potential side power supply voltage VSS”. The terminal portion 30 of the liquid crystal panel 10 includes the plurality of input/output terminals 300 for connecting the signal wires formed on the FPC 20 electrically with the LSI 200, the input/output terminal 310 for supplying the high-potential side power supply voltage VDD to the LSI 200, and the input/output terminal 320 for supplying the low-potential side power supply voltage VSS to the LSI 200. The LSI 200 is provided with the plurality of bumps 50 for connecting the LSI 200 electrically with the intra-panel electric circuit 110. The LSI 200 is also provided with an intra-LSI high-potential side power supply voltage line 51 for connecting the input/output terminal 310 with the bump 50, and an intra-LSI low-potential side power supply voltage line 52 for connecting the input/output terminal 320 with the bump 50. Moreover, the liquid crystal panel 10 is provided with an intra-panel high-potential side power supply voltage line 53 for supplying the high-potential side power supply voltage VDD to the electric circuit in the liquid crystal panel 10, and an intra-panel low-potential side power supply voltage line 54 for supplying the low-potential side power supply voltage VSS to the electric circuit in the liquid crystal panel 10.

In the intra-panel protective circuit 120, signal lines for connecting the bumps 50 with the intra-panel electric circuit 110 are connected with two diodes 121 and 122, respectively. More specifically, the signal lines for connecting the bumps 50 with the intra-panel electric circuit 110 are connected with an anode of the diode 121 and a cathode of the diode 122, respectively. Moreover, a cathode of the diode 121 is connected with the intra-panel high-potential side power supply voltage line 53, and an anode of the diode 122 is connected with the intra-panel low-potential side power supply voltage line 54.

In the intra-LSI protective circuit 220, signal lines for connecting the input/output terminals 300 with the bumps 50 are connected with two diodes 221 and 222, respectively. More specifically, the signal lines for connecting the input/output terminals 300 with the bumps 50 are connected with an anode of the diode 221 and a cathode of the diode 222, respectively. Moreover, a cathode of the diode 221 is connected with the intra-LSI high-potential side power supply voltage line 51, and an anode of the diode 222 is connected with the intra-LSI low-potential side power supply voltage line 52.

### 2.3 Operations upon Reception of Static Electricity

With reference to FIG. 8, next, description will be made about operations when the input/output terminal 300 of the liquid crystal panel 10 receives static electricity, in the present embodiment.

When the input/output terminal 300 receives positive static electricity, the input/output terminal 300 increases in potential. Thus, when a forward voltage is applied to the diode 221, positive electric charges resulting from the static electricity flow partially from the input/output terminal 300 into the intra-LSI high-potential side power supply voltage line 51. Further, when the bump 50 increases in potential and a forward voltage is applied to the diode 121, positive electric charges resulting from the static electricity flow partially from the bump 50 into the intra-panel high-potential side power supply voltage line 53.

When the input/output terminal 300 receives negative static electricity, the input/output terminal 300 decreases in potential. Thus, when a forward voltage is applied to the diode 222, negative electric charges resulting from the static electricity flow partially from the input/output terminal 300 into the intra-LSI low-potential side power supply voltage line 52. Further, when the bump 50 decreases in potential and a forward voltage is applied to the diode 122, negative electric charges resulting from the static electricity flow partially from the bump 50 into the intra-panel low-potential side power supply voltage line 54.

### 2.4 Effects

As described above, according to the present embodiment, when the input/output terminal 300 of the liquid crystal panel 10 receives static electricity, electric charges of the static electricity flow into the intra-LSI protective circuit 220 and the intra-panel protective circuit 120. In a case where the input/output terminal 300 increases in potential, when a forward voltage is applied to the diode 221, positive electric charges flow into the intra-LSI high-potential side power supply voltage line 51, and moreover, when a forward voltage is applied to the diode 121, positive electric charges flow into the intra-panel high-potential side power supply voltage line 53. On the other hand, in a case where the input/output terminal 300 decreases in potential, when a forward voltage is applied to the diode 222, negative electric charges flow into the intra-LSI low-potential side power supply voltage line 52, and moreover, when a forward voltage is applied to the diode 122, negative electric charges flow into the intra-panel low-potential side power supply voltage line 54. Thus, the electric charges of the static electricity are discharged by the intra-LSI protective circuit 220 and the intra-panel protective circuit 120.

As described above, when the input/output terminal 300 of the liquid crystal panel 10 receives static electricity, electrical discharge for preventing electrostatic breakage of the intra-panel electric circuit 110 is performed not only by the intra-panel protective circuit 120 but also by the intra-LSI protective circuit 220. Therefore, an electrostatic withstand voltage in the entire display device becomes high, so that, even in a case where the input/output terminal 300 receives static electricity excessively, the occurrence of a malfunction to be caused due to electrostatic breakage of the intra-panel electric circuit 110 can be suppressed.

### 2.5 Modification

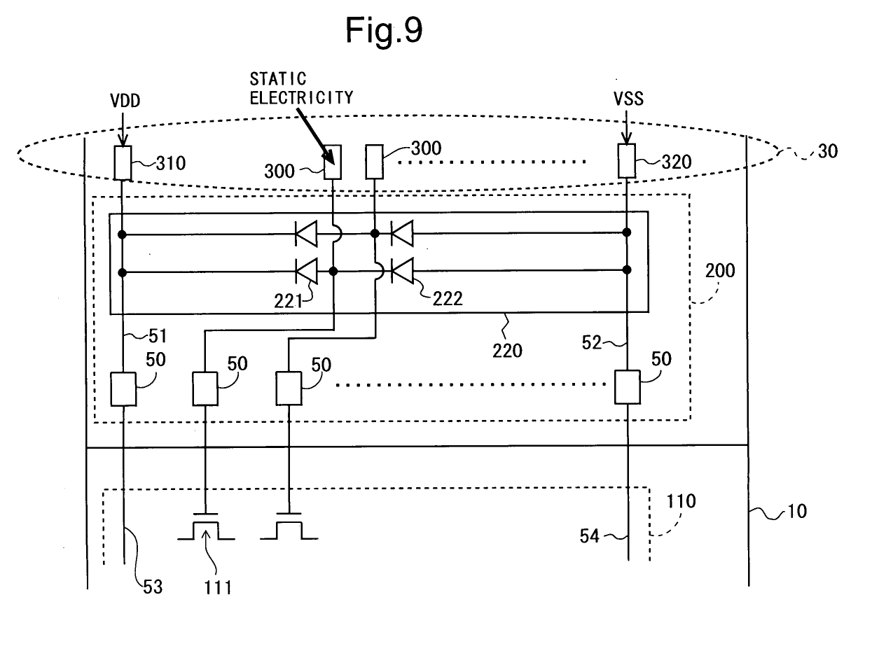

Next, description will be given of a modification of the second embodiment. FIG. 9 is an equivalent circuit diagram showing detailed configurations of the intra-LSI protective circuit 220 and the peripheral circuit thereof in the modification of the second embodiment. In this modification, different from the second embodiment, the intra-panel protective circuit 120 is not provided. In a case where provision of only the intra-LSI protective circuit 220 is sufficient to bring a satisfactory electrostatic withstand voltage, it may configured that the intra-panel protective circuit 120 is not provided as described in this modification, which can lead to reduction in cost.

### 3. Others

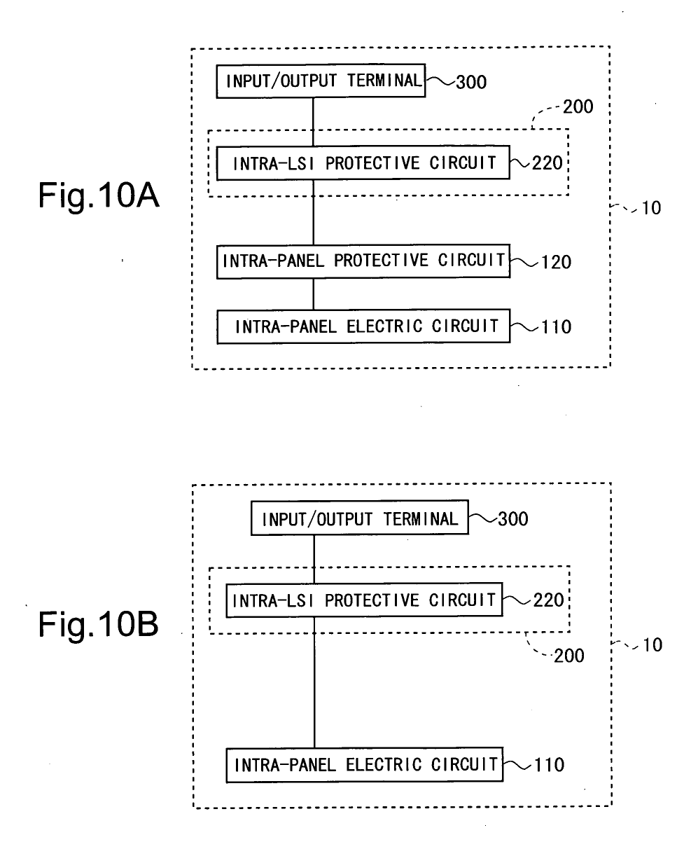

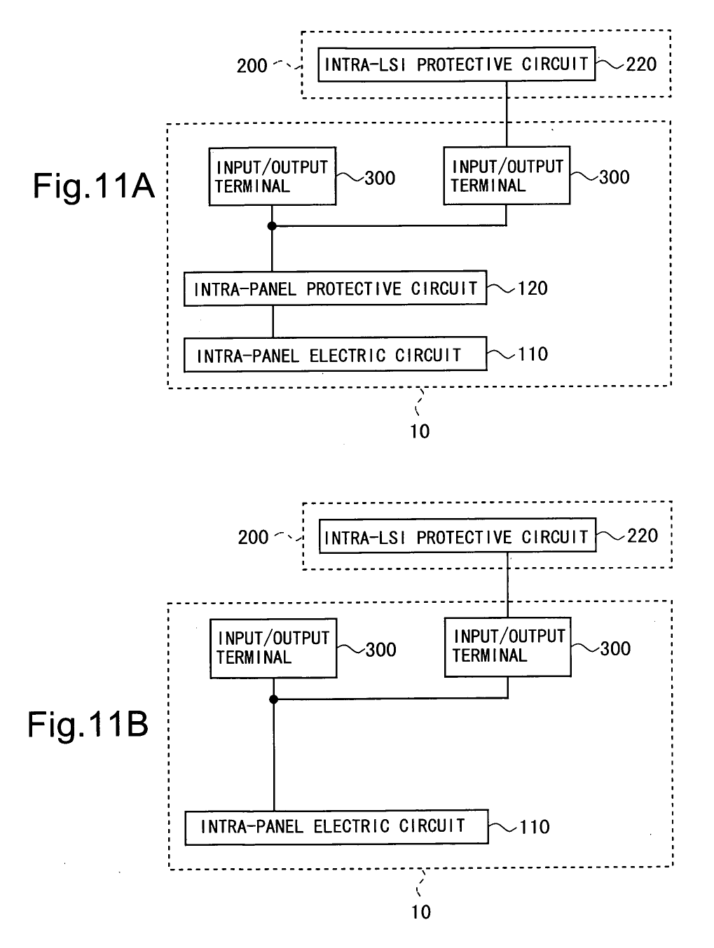

There are various connection relations among the input/output terminal 300 in the liquid crystal panel 10, the intra-panel electric circuit 110 and the protective circuits (the intra-panel protective circuit 120 and the intra-LSI protective circuit 220), and with reference to FIG. 10 and FIG. 11, description will be made about this. FIG. 10A and FIG. 10B each shows a configuration example of the liquid crystal display device adopting a COG method as a mounting method. FIG. 11A and FIG. 11B each shows a configuration example of the liquid crystal display device adopting the COG method or a COF method as a mounting method.

According to the configuration as shown in FIG. 10A, the input/output terminal 300 is connected with the intra-LSI protective circuit 220, the intra-LSI protective circuit 220 is connected with the intra-panel protective circuit 120, and the intra-panel protective circuit 120 is connected with the intra-panel electric circuit 110. According to this configuration, the intra-panel electric circuit 110 is protected, from the static electricity which the input/output terminal 300 receives, by the intra-LSI protective circuit 220 and the intra-panel protective circuit 120.

According to the configuration as shown in FIG. 10B, the input/output terminal 300 is connected with the intra-LSI protective circuit 220, and the intra-LSI protective circuit 220 is connected with the intra-panel electric circuit 110. According to this configuration, the intra-panel electric circuit 110 is protected, from the static electricity which the input/output terminal 300 receives, by the intra-LSI protective circuit 220. In a case where provision of the intra-LSI protective circuit 220 is sufficient to bring a satisfactory electrostatic withstand voltage, this configuration achieves reduction in cost.

According to the configuration as shown in FIG. 1A, the input/output terminal 300 is connected with the intra-panel protective circuit 120, and the intra-panel protective circuit 120 is connected with the intra-panel electric circuit 110. As for the input/output terminals 300 and the intra-LSI protective circuit 220, some are connected each other and others are not connected each other. For example, it may be configured that the inspecting input/output terminals are not connected with the intra-LSI protective circuit 220, and that the input/output terminal to be used actually are connected with the intra-LSI protective circuit 220. According to this configuration, in actual use, the intra-panel electric circuit 110 is protected, from the static electricity which the input/output terminal 300 receives, by the intra-LSI protective circuit 220 and the intra-panel protective circuit 120.

According to the configuration as shown in FIG. 11B, the input/output terminal 300 is connected with the intra-panel protective circuit 120. Moreover, as for the input/output terminals 300 and the intra-LSI protective circuit 220, some are connected each other and others are not connected each other. For example, it may be configured that the inspecting input/output terminals are not connected with the intra-LSI protective circuit 220, and that the input/output terminal to be used actually are connected with the intra-LSI protective circuit 220. According to this configuration, in actual use, the intra-panel electric circuit 110 is protected, from the static electricity which the input/output terminal 300 receives, by the intra-LSI protective circuit 220. In a case where provision of the intra-LSI protective circuit 220 is sufficient to bring a satisfactory electrostatic withstand voltage, this configuration achieves reduction in cost.

Moreover, in each of the foregoing embodiments, the CG silicon liquid crystal display device has been described as an example; however, the present invention is not limited to this and is applicable to a display device where an electric circuit is formed on a display panel. For example, in the display device including a gate driver in the display panel, it may be configured that a TFT in the gate driver is made of amorphous silicon or polysilicon. Further, the present invention is applicable to an electronic device provided with the display device described above.

Furthermore, in each of the foregoing embodiments, the diode serves as a protective element in the protective circuit; however, the present invention is not limited to this and the protective circuit may be configured by a protective element other than the diode. Moreover, a detailed circuit configuration of the protective circuit is not limited; for example, resistors are provided.

1. A display device comprising:
a display panel including a display unit for displaying an image, an electric circuit, and an input/output terminal for receiving a predetermined electric signal to be given to the electric circuit; and
an integrated circuit connected electrically with the display panel, wherein
the integrated circuit includes a first protective circuit for discharging electric charges of static electricity given to the input/output terminal.

2. The display device according to claim 1, wherein
the electric circuit includes a drive circuit for displaying the image on the display unit, and
the integrated circuit controls operations of the drive circuit.

3. The display device according to claim 1, wherein
the electric circuit includes a power supply circuit for activating a predetermined circuit in the display panel.

4. The display device according to claim 1, wherein
the display panel includes a second protective circuit for discharging the electric charges of the static electricity given to the input/output terminal.

5. The display device according to claim 4, wherein
the input/output terminal is connected with the first protective circuit and the second protective circuit.

6. The display device according to claim 4, wherein
the first protective circuit is connected with the input/output terminal and the second protective circuit.

7. The display device according to claim 1, wherein
the display panel includes a glass substrate, and
the integrated circuit is mounted on the glass substrate.

8. The display device according to claim 1, further comprising
a flexible printed circuit connected electrically with the display panel, wherein
the integrated circuit is mounted on the flexible printed circuit.

9. The display device according to claim 2, wherein
the drive circuit is configured by a thin film transistor made of continuous grain silicon.

10. The display device according to claim 2, wherein
the drive circuit is configured by a thin film transistor made of amorphous silicon.

11. The display device according to claim 2, wherein
the drive circuit is configured by a thin film transistor made of polysilicon.

12. An electronic device comprising
a display device having
a display panel including a display unit for displaying an image, an electric circuit, and an input/output terminal for receiving a predetermined electric signal to be given to the electric circuit, and
an integrated circuit connected electrically with the display panel, wherein
the integrated circuit includes a first protective circuit for discharging electric charges of static electricity given to the input/output terminal.

13. The electronic device according to claim 12, wherein
the electric circuit includes a drive circuit for displaying the image on the display unit, and
the integrated circuit controls operations of the drive circuit.

14. The electronic device according to claim 12, wherein
the electric circuit includes a power supply circuit for activating a predetermined circuit in the display panel.

15. The electronic device according to claim 12, wherein
the display panel includes a second protective circuit for discharging the electric charges of the static electricity given to the input/output terminal.

16. The electronic device according to claim 15, wherein
the input/output terminal is connected with the first protective circuit and the second protective circuit.

17. The electronic device according to claim 15, wherein
the first protective circuit is connected with the input/output terminal and the second protective circuit.

18. The electronic device according to claim 12, wherein
the display panel includes a glass substrate, and
the integrated circuit is mounted on the glass substrate.

19. The electronic device according to claim 12, further comprising
a flexible printed circuit connected electrically with the display panel, wherein
the integrated circuit is mounted on the flexible printed circuit.

20. The electronic device according to claim 13, wherein
the drive circuit is configured by a thin film transistor made of continuous grain silicon.

21. The electronic device according to claim 13, wherein
the drive circuit is configured by a thin film transistor made of amorphous silicon.

22. The electronic device according to claim 13, wherein
the drive circuit is configured by a thin film transistor made of polysilicon.
